(19) United States
(12) Patent Application Publication
(10) Pub. No.: US 2002/0176108 A1
(43) Pub. Date: Nov. 28, 2002

(54) Printer with facsimile function capable of selectively printing fax data and selective printing method thereof

(76) Inventor: Cheol-Min Jeon, Gumi-city (KR)

Correspondence Address: ROBERT E. BUSHNELL, 1522 K STREET NW, SUITE 300, WASHINGTON, DC, 200051202

(21) Appl. No.: 09/983,610

(22) Filed: Oct. 25, 2001

(30) Foreign Application Priority Data
May 24, 2001 (KR) 28608/2001

(51) Int. Cl. G06F 15/00; B41J 1/00

(52) U.S. Cl. 358/1.15

(57) ABSTRACT

A printer with a facsimile function is capable of selectively printing fax data in accordance with a selective printing method thereof. Fax reception information about fax data received through a wired/wireless communication network is outputted. A user checks a user terminal, and transmits a printing command to a printer, calling for the received fax data to be printed. A controlling portion causes the fax data to be printed in accordance with the command by the user. Since the user can decide whether or not to print the fax data, unnecessary printing can be avoided, and accordingly, the cost of consumables, such as ink, toner, paper, etc., can be reduced. Further, since the fax data is checked in the user terminal and stored in a storing device provided in, or connected to, the user terminal, the received fax data can be edited without requiring a separate scanning process.

### CLAIM OF PRIORITY

This application makes reference to, incorporates the same herein, and claims all benefits accruing under 35 U.S.C. §119 from my application MULTIFUNCTION PRINTER AND SELECTIVE PRINTING METHOD OF FACSIMILE DATA filed with the Korean Industrial Property Office on May 24, 2001 and there duly assigned Serial No. 28608/2001.

### BACKGROUND OF THE INVENTION

1. Technical Field

The present invention relates to a multi function printer having the function of a facsimile machine and a printing method thereof. More particularly, the invention relates to a multi function printer capable of controlling whether or not to print received fax data, and a printing method for selectively printing received fax data on the multi function printer.

2. Related Art

Generally, a multi function printer has not only the function of a printer that prints data received from a user computer, but also the function of a facsimile, a scanner, a photocopier, and the like. That is, the multi function printer is the combination of a printer and various general units, such as facsimile, scanner, photocopier, and the like, and it also serves as a PC interface device for an IEEE 1284 (Institute of Electrical and Electronics Engineers 1284) signal.

While the multi function printer has the advantage of economical cost due to its structure in which the respective units are integrated into one, the multi function printer also has a considerable number of problems. One of the problems is a high maintenance cost. That is, since the multi function printer is formed by adding units of respective functions to the printer, it requires relatively high maintenance cost. For example, it usually takes 100 Korean won (8 cents) for the inkjet printer to print data in black and white on one side of A4-size paper, and 200 Korean won (16 cents) to print data in color, while a photocopier or facsimile machine prints data at a cost lower than that of the inkjet printer.

Also, it often occurs that received fax data is not what the user wants to receive. However, regardless of the intent of the user, all received data is printed, thereby incurring unnecessary expense. Further, since the existing multi function printer does not have the function of transmitting data to a user computer, the user cannot edit or store received data in his/her computer. Accordingly, in order to edit or store the received fax data in his/her computer, the user has to scan the printout.

### SUMMARY OF THE INVENTION

The present invention has been developed in order to overcome the above-mentioned problems of the related art, and accordingly, it is an object of the present invention to provide a printer with facsimile function that reduces the cost of consumables that would otherwise be incurred due to printing of received data irrespective of certain circumstances.

Another object is to provide a method for printing fax data which reduces the cost of consumables that would otherwise be incurred due to printing of received data irrespective of certain circumstances.

The above object is accomplished by a printer with facsimile function in accordance with the present invention. The printer includes a fax receiving portion for receiving fax data, a printing portion for printing the fax data received through the fax receiving portion, a command receiving portion for receiving a command input from a user as to whether or not to print the received fax data, and a fax controlling portion for transmitting the received fax data to the printing portion through the fax receiving portion when receiving a printing command through the command receiving portion. Since the user can decide whether or not to print the received fax data, unnecessary printing of the received data can be prevented.

It is preferable that the printer with facsimile function in accordance with the present invention further include a storing portion for storing the fax data received through the fax receiving portion. By storing the received fax data, the fax data can be held for a later opportunity (e.g., for later printing).

It is also preferable that the printer with facsimile function in accordance with the present invention further include a selection portion by means of which the user can make a selection between storing and printing of the fax data received through the fax receiving portion. Accordingly, two modes for fax data printing can be provided: a first mode in which facsimile printing is performed according to the selection of the user, and another mode in which facsimile printing is provided without selection by the user.

Another object is accomplished by a method for selectively printing fax data in a printer with a facsimile function in accordance with the present invention. The method includes the steps of (a) receiving fax data, (b) outputting fax reception information that includes at least some part of the received fax data and/or information about reception of the fax data, and (c) printing the received fax data in accordance with a selection made by a user after the user's check of the fax reception information.

Before step (a) of the method in accordance with the present invention, two further steps can be performed as follows: (a1) determining whether or not there is a save mode in effect, and (a2) storing the received fax data when it is determined that the save mode is in effect. Steps (b) and (c) of the above method are performed when the save mode is determined to be in effect. Accordingly, two modes for fax data printing are provided: a first one performed according to the selection of the user, and another one in which fax data printing is performed regardless of the selection of the user.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, and wherein:

FIG. 1 is a block diagram showing a printer with facsimile function capable of selectively printing received fax data in accordance with a preferred embodiment of the present invention; and

FIG. 2 is a flowchart illustrating a process or method of the printer with facsimile function for selectively printing the received fax data in accordance with the preferred embodiment of the present invention.

### DETAILED DESCRIPTION OF PREFERRED EMBODIMENT

A detailed description of the preferred embodiment of a printer with facsimile function and a printing method thereof for selectively printing fax data in accordance with the present invention is now provided with reference to the attached drawings.

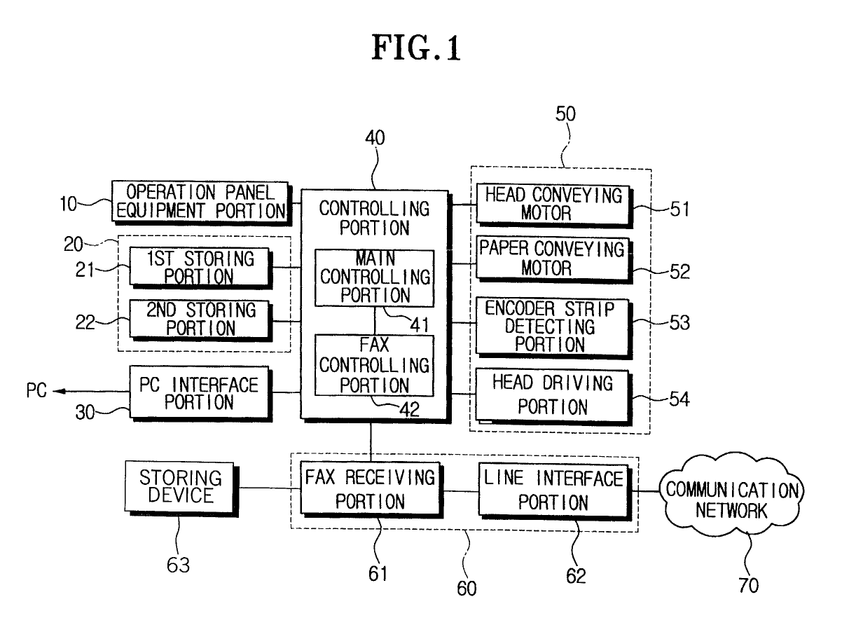

FIG. 1 is a block diagram showing a printer with facsimile function capable of selectively printing fax data in accordance with the preferred embodiment of the present invention.

Referring to FIG. 1, a printer with facsimile function is capable of selectively printing the fax data in accordance with the present invention, and includes an operation panel equipment (OPE) portion 10, a memory portion 20, a PC interface portion 30, a controlling portion 40, a printer portion 50, and a facsimile portion 60.

The OPE portion 10 has a plurality of operation buttons thereby enabling a user to control the operation of the printer at the hardware level, and a light emission diode (LED) or a liquid crystal display (LCD) that indicates the operational status of the printer.

The memory portion 20 includes a first storing portion 21 storing a program for operation of the printer, and a second storing portion 22 storing data generated during the operation of the printer. Usually, the first storing portion 21 is a nonvolatile memory element, and the second storing portion 22 is a volatile memory element.

The PC interface portion 30 interconnects the printer and a user computer, and is usually connected to a parallel port of the user computer. The PC interface portion 30 receives a command from the user through the user terminal. The user terminal usually is a computer, but any device having an information processing function can also be used. The command can also be input through a user interface device, such as a button or a touch screen provided at the printer.

The printer portion 50 includes a head conveying motor 51, a paper conveying motor 52, an encoder strip detector or detecting portion 53, and a head driving portion 54.

The head conveying motor 51 includes a conveying motor that conveys a printer head to the left and right, and a motor control circuit (not shown) that controls the conveying motor. The head conveying motor 51 moves the printer head to an appropriate position during the printing operation. The paper conveying motor 52 includes a motor that moves the paper on which data is printed, and a motor control circuit (not shown). During the printing operation, the paper conveying motor 52 moves the paper to an initial position, or advances the paper in accordance with line feed information for the printing data.

The encoder strip detector or detecting portion 53 detects the change of a strip with a sensor when the printer head is moved by the head conveying motor 51. The encoder strip detector 53 counts changes of the strip, determines the position of the printer head, detects changing speed of the strip, and receives feedback relative to the driving speed of the head conveying motor 51. The head driving portion 54 includes a data transmitting portion that transmits data to be printed on the printer head, and a nozzle driving portion that drives nozzles of the printer head.

The facsimile portion 60 includes a fax receiving portion 61 and a line interface portion 62, and sends and receives fax data. The fax receiving portion 61 encodes fax data for transmission in a format transmittable through a communication network 70, or decodes received fax data so as to provide it in a format printable in the printing portion 50. The line interface portion 62 connects the fax receiving portion 61 to the communication network 70, and thus enables fax data transmission and reception. The communication network 70 includes wired communication networks, such as a public switched telephone network and a wireless communication network.

The controlling portion 40 includes a main controlling portion 41 and a fax controlling portion 42. The main controlling portion 41 controls the operation of the printer head in accordance with the program stored in the first storing portion 21, and also controls the operation of other constituents. When the fax controlling portion 42 receives a command for printing through the PC interface portion 30 or through a user interface device provided in the printer, the fax controlling portion 42 transmits the fax data received through the fax receiving portion 61 to the printing portion 50. The fax controlling portion 42 may also have such a function that, when the fax controlling portion 42 receives fax data through the fax receiving portion 61, the fax controlling portion 42 transmits to the user terminal at least some part of the received fax data and/or information about the reception of the fax data (e.g., identity of the sender, title of the fax, etc.). The fax controlling portion 42 can be integrated with the main controlling portion 41.

The printer with facsimile function capable of selectively printing fax data in accordance with the present invention further includes a separate storing device 63 that stores the fax data received through the fax receiving portion 61. In such a case, the fax controlling portion 42 stores the received fax data in the storing device 63. Also, according to a command received from the user, the fax controlling portion 42 deletes or prints, or transmits to the user terminal, the fax data stored in the storing device 63. When there is no separate storing device provided, as the received fax data is, preferably, stored in the second storing portion 22.

The printer with facsimile function capable of selectively printing fax data in accordance with the present invention further includes a selection portion through which the user can select storing and printing of the fax data received through the fax receiving portion 61. The selection portion can be in the form of a save mode button in the OPE 10. Alternatively, operational mode can also be shifted in accordance with a control signal input from the user terminal. The fax controlling portion 42 controls the process of storing fax data received through the facsimile portion 60 in the second storing portion 22, or in a separately provided storing device 63, and the process of printing the received fax data through the printer portion 50.

Considering the case wherein the selection portion is in the form of a save mode button in the OPE 10, when the save mode button is turned on, received fax data is not printed, but rather it is stored in the separate storing device 63. Meanwhile, when the save mode button is turned off, the fax data is not stored, but it is directly printed according to the general printing process of the multi function printer.

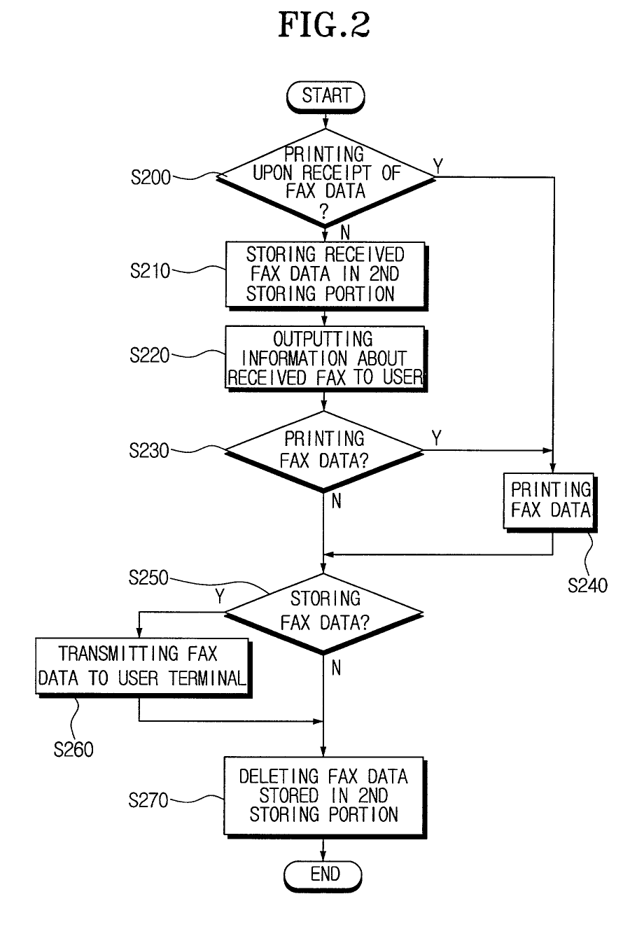

FIG. 2 is a flowchart illustrating the method for selectively printing fax data in the printer with facsimile function in accordance with the present invention.

Referring to FIG. 2, when the fax data is received from the fax receiving portion 61 through the line interface portion 62 connected to the communication network 70, the fax controlling portion 42 checks the setting status of the selection portion (step S200). If the selection portion is set to perform printing upon receipt of fax data, the fax data is printed according to the general printing process of the multi function printer (step S240).

If the selection portion is not set to perform printing but is set to perform storing upon receipt of the fax data, the fax data is stored in the second storing portion 22 (step S210), and information about the receipt of the fax data is outputted to the user terminal, such as a PC, or the like (step S220). The information about the receipt of the fax data may be in the form of a notice, such as ‘FAX RECEIVED’, outputted to the user terminal, or may be in a more complicated form that includes at least some part of the received fax data (e.g., identity of the sender, title of the fax, etc.). The information about the receipt of fax data, such as the notice of ‘FAX RECEIVED’, is outputted to the user terminal through a popup window, a dialog box, or the like. Also, the information about the receipt of the fax data can be outputted to the user interface device provided in the printer.

The user checks the fax receipt information outputted to the user terminal, and decides whether or not to print the received fax data (step S230). If the user decides to print the received fax data, the fax controlling portion 42 outputs a signal to the printer portion 50, instructing it to print the fax data stored in the second storing portion 22, and the printer portion 50 prints the fax data (step S240).

Meanwhile, it is preferable that the user be enabled to delete the fax data from the second storing portion 22, or to store the fax data in the user terminal. More specifically, after performing steps S230 and S240, the user can select whether or not to store the fax data in the user terminal. In this case, the fax receipt information outputted to the user terminal preferably includes the entire content of the received fax data.

After checking the content of the fax data, the user decides whether or not to store the received fax data in the user terminal (step S250). If the user wants to store the received fax data, the fax controlling portion transmits the fax data stored in the second storing portion 22 to the user terminal (step S260). The user may also store fax data in a storing device provided with, or connected to, the user terminal.

After performing the above steps, for more efficient utilization of memory, it is preferable that the received fax data be deleted from the second storing portion 22 if the user does not want to store the received fax data in S250 (step S270). The deletion can be performed after step S250, or after step S260 that transmits the fax data to the user terminal. Alternatively, the fax data stored in the second storing portion 22 may also be deleted upon receipt of a delete command input from the user.

The fax data can be outputted and stored in the user terminal through a program that is installed in the user terminal specifically for the purpose of outputting fax data. Alternatively, the fax data received from the fax controlling portion 42 can be converted into an appropriate format for a word processing program or graphic program, such as the ‘Hangul Wordian’, MS-words, etc., to be output or stored.

According to the printer with facsimile function capable of selectively printing the fax data and the selective printing method thereof in accordance with the present invention, the user can select to receive a notice of the reception of the fax data, and accordingly the fax data is not printed directly upon receipt. Since the user can check the content of the received fax data in the user terminal before he/she decides to delete, store or print the received fax data, cost for consumables, such as ink, toner, and paper, can be reduced.

Further, since the user can store the received fax data in the storing device provided in, or connected to, the user terminal after checking the content of the received fax data in the user its terminal, there is no need for separate scanning, and the user has the advantage of being able to edit the received fax data. Since the above-described function also can be realized by using the memory of a general inkjet printer or a laser printer having facsimile function, it becomes cost-effective.

Although a preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A printer with a facsimile function, comprising:
a fax receiving portion for receiving fax data;
a printing portion for printing the fax data received by the fax receiving portion;
a command receiving portion for receiving a command input by a user indicating whether or not to print the received fax data; and
a fax controlling portion for transmitting the received fax data to the printing portion through the fax receiving portion when the command input indicates printing of the received fax data.

2. The printer with facsimile function of claim 1, wherein the command receiving portion comprises an interface device for interfacing with a user terminal.

3. The printer with facsimile function of claim 2, wherein the fax controlling portion transmits, to the user terminal, at least one of at least some of the fax data and information about reception of the fax data when the fax data is received by the fax receiving portion.

4. The printer with facsimile function of claim 1, further comprising a storing portion for storing the fax data received through the fax receiving portion.

5. The printer with facsimile function of claim 4, wherein the fax controlling portion transmits, to the user terminal, the fax data stored in the storing portion when the fax receiving portion receives a command for fax data transmission from the user terminal.

6. The printer with facsimile function of claim 4, wherein the fax controlling portion deletes the fax data from the storing portion when the fax controlling portion receives a command for fax data deletion from the user terminal through the command receiving portion.

7. The printer with facsimile function of claim 4, further comprising a selection portion through which the user makes a selection between storing and printing of the fax data received through the fax receiving portion, the fax controlling portion controlling the storing of the fax data received through the fax receiving portion and the printing of the fax data through the printing portion in accordance with the selection made by the user through the selection portion.

8. The printer with facsimile function of claim 7, wherein the selection portion comprises a save mode button provided in an operation panel equipment portion.

9. A method for selectively printing fax data in a printer with a facsimile function, the method comprising the steps of:
(a) receiving fax data;
(b) outputting fax reception information that includes at least one of at least some part of the received fax data and information about reception of the fax data; and
(c) printing the received fax data in accordance with a selection made by a user after a check of the fax reception information by the user.

10. The method of claim 9, wherein step (b) further comprises the step of storing the received fax data in a user terminal in accordance with the selection made by the user.

11. The method of claim 9, further comprising the steps, before step (a), of:
(a1) determining whether a save mode is in effect; and
(a2) storing the received fax data when it is determined that the save mode is in effect; and
wherein steps (b) and (c) are performed when it is determined that the save mode is in effect.

12. The method of claim 11, further comprising the step (d) of deleting the stored fax data according to the selection made by the user.

13. The method of claim 9, wherein the fax reception information includes at least one of at least some information about a sender of the received fax data and a title of the received fax data.

14. A printer having a facsimile function, comprising:
fax receiving means for receiving fax data;
printing means for printing the fax data received by said fax receiving means;
storing means for storing the fax data received through said fax receiving means;
selection means responsive to a user for indicating a user selection between storing and printing of the fax data received by said fax receiving portion; and
fax controlling means for controlling the storing of the fax data received by said fax receiving means and the printing of the fax data by said printing means in accordance with the user selection indicated by said selection means.

15. The printer of claim 14, further comprising command receiving means for receiving a command input from the user indicating whether or not to print the received fax data.

16. The printer of claim 14, wherein said fax controlling means transmits, to a user terminal, at least one of at least some of the fax data and information about reception of the fax data when the fax data is received by said fax receiving means.

17. The printer of claim 14, wherein said fax controlling means transmits, to a user terminal, the fax data stored in said storing means when said fax receiving means receives a command for fax data transmission from the user terminal.

18. The printer of claim 14, wherein said fax controlling means deletes the fax data from said storing means when said fax controlling means receives a command for fax data deletion from the user terminal.

19. The printer of claim 14, wherein said selection means comprises a save mode button provided in an operation panel equipment portion.
